(19) United States
(12) Patent Application Publication
(10) Pub. No.: US 2013/0006416 A1
(43) Pub. Date: Jan. 3, 2013

(54) CUSTOMER USAGE STATISTICS GATHERING WITHIN VENDING MACHINES

(75) Inventors: James M. Canter, Austin, TX (US); William C. Royal, JR., Oak Ridge, NC (US); Steven Joel Blachman, Pflugerville, TX (US); Bryan W. Godwin, Round Rock, TX (US)

(73) Assignee: CRANE MERCHANDISING SYSTEMS, INC., Bridgeton, MO (US)

(21) Appl. No.: 13/476,852

(22) Filed: May 21, 2012

Related U.S. Application Data
(60) Provisional application No. 61/488,071, filed on May 19, 2011.

(51) Int. Cl. G06F 17/00

(52) U.S. Cl. 700/236

(57) ABSTRACT

A vending machine is configured to collect rich customer insight information, including time-based records of the customer interaction with the vending machine during a vend transaction. Customer menu selections, brand information associated with customer payment or product selections, and promotions or displays triggering customer input are logged for analysis to provide further information regarding customer sales and promotion responses.

### CROSS-REFERENCE TO RELATED APPLICATION(S) AND CLAIM OF PRIORITY

The present application claims priority to U.S. Provisional Patent Application Ser. No. 61/488,071, filed May 19, 2011, entitled “CUSTOMER USAGE STATISTICS GATHERING WITHIN VENDING MACHINES.” The content of the above-identified patent document is incorporated herein by reference.

### TECHNICAL FIELD

The present application relates generally to gathering customer-based activity information in connection with unattended retail transactions and, more specifically, to a gathering customer-based activity information in vending machines.

### BACKGROUND

Vending machines offer unattended sales of commodities such as snacks, canned or bottled beverages, or any of a variety of other articles. However, historically vending machines have been “black boxes” placed into service in the field and with little known afterwards about how they operate as unattended points of sale with regards to the consumer.

“Customer insight” refers to a rich collection of consumer-based activities (i.e., consumer usage/purchase statistics) on a vending machine. Vending machines may collect data about sales activities in the form of period counters (e.g., daily) as represented by the Digital Exchange (DEX) standard ASCII-based electronic audit files, developed to improve audit capabilities in vending machines. However, vending machines fail to catalog any rich collection of time-based activities that occur when a consumer interacts with the vending machine. DEX, for instance, does not provide a rich collection of customer usage information.

There is, therefore, a need in the art for a system, method, and apparatus that collects rich customer insight within vending machines and gathers customer usage statistics.

### SUMMARY

A vending machine is configured to collect rich customer insight information, including time-based records of the customer interaction with the vending machine during a vend transaction. Customer menu selections, brand information associated with customer payment or product selections, and promotions or displays triggering customer input are logged for analysis to provide further information regarding customer sales and promotion responses.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a vending network including at least one vending machine that implements a customer usage statistics collection system to collect rich customer insight data according to embodiments of the present disclosure;

FIG. 2 illustrates a vending machine that implements a customer usage statistics collection system according to embodiments of the present disclosure;

FIG. 3 is a block diagram of selected electrical and electronic components of the vending machine of FIG. 2;

FIG. 4 illustrates a partial database entity relationship diagram for implements a customer usage statistics collection system according to embodiments of the present disclosure; and

FIG. 5 is a high level flow chart for a process of customer usage statistics collection according to embodiments of the present disclosure.

### DETAILED DESCRIPTION

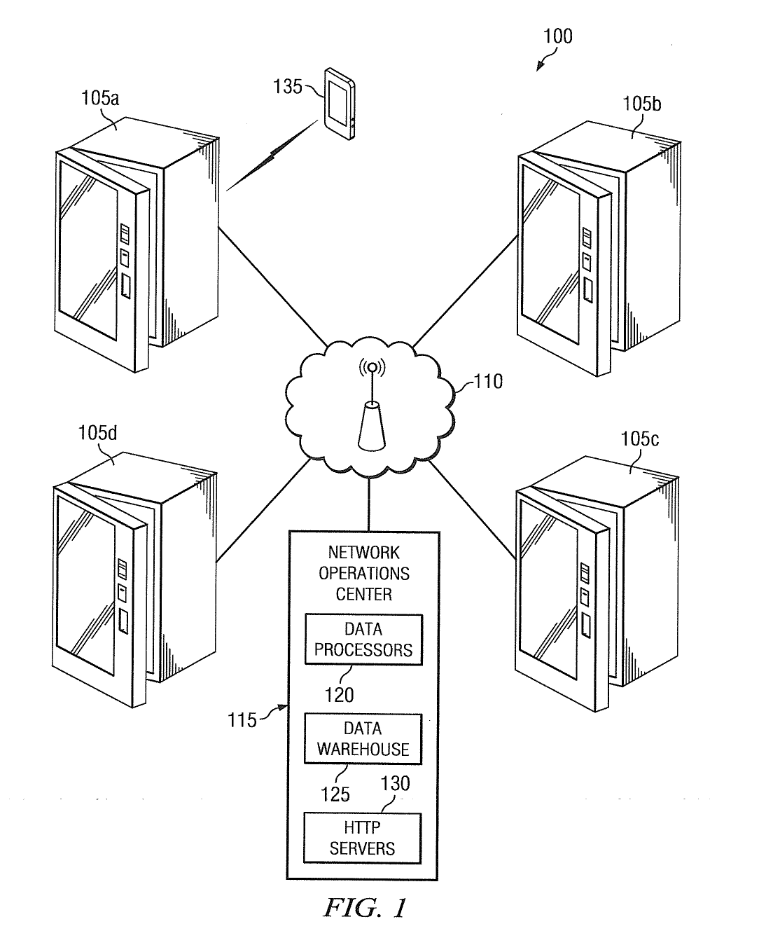

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine system.

FIG. 1 illustrates a vending network including a vending machine that implements a customer usage statistics collection system to collect rich customer insight data according to embodiments of the present disclosure. Although certain details will be provided with reference to the components of the vending network 100 of FIG. 1, it should be understood that other embodiments may include more, less, or different components. Vending Network 100 includes a plurality of vending machines 105a through 105d. Each vending machine 105a through 105d is coupled to a data communications system 110. In certain embodiments, the network 100 includes one vending machine 105 coupled to a data communication system 110. That is, one or more of the vending machines 105 are not directly coupled to the data communications system 110. The data communications system 110 facilitates data communications between at least one vending machine 105 and a central facility, such as a network operations center 115.

The data communications system 110 can be implemented in a known manner, such as by utilizing any one or combination of: an Internet Protocol (IP), a HyperText Transmission Protocol (HTTP) communication over the Internet (i.e., the world wide web), and secured by authentication and encryption processes to create a Virtual Private Network (VPN). One or more of the vending machines 105a through 105d communicate to the data communications system 110 using a wireless communication, wired communication, or a combination of wired and wireless communications. The communications between the data communications system 110 and the vending machines 105a through 105d can utilize known IP and/or HTTP access and communication methods.

The network operations center includes a number of components such as data processors 120, a data warehouse 125 and Hypertext Transfer Protocol (HTTP) servers 130. Accordingly, using the communications provided by the data communications system 110, vending machines 105a through 105d connect to the network operations center 115 and the components contained within the network operations center 115. In certain embodiments, the data processors 120 are connected to data warehouse 125 and HTTP servers 130. The data processors 120 send and receive data to and from the data warehouse 120 and HTTP servers 130. The data processors 120 perform calculations using the data received from data warehouse 125, HTTP servers 130, or both. In certain embodiments, one or more of the vending machines 105a through 105d send data to data processors 120. In certain embodiments, one or more of the vending machines 105a through 105d send data to data warehouse 125. The data warehouse 125 is capable of storing data in databases, such as rich structured query language (“SQL”) databases. Through a connection with HTTP servers 109, one or more of the vending machines 105a through 105d connects to the Internet (i.e., the world wide web) and accesses websites and retrieves data therefrom.

In certain embodiments, one or more of vending machines 105a through 105d are configured to wirelessly communicate with a user device 135. User device 135 can be a portable computer, a “smart phone”, personal data assistant, a touchscreen tablet, an electronic wallet, or the like. The user device 135 is configured to communicate with one or more of the vending machines 105a through 105d using wireless or wired communications links. For example, the user device 135 can be configured to communicate with one or more of the vending machines 105a through 105d utilizing a near field communication (NFC), wireless fidelity (Wi-Fi) (e.g., IEEE 802.11) communication, BLUETOOTH low energy (BLE) communication, or any other suitable wireless communications protocol.

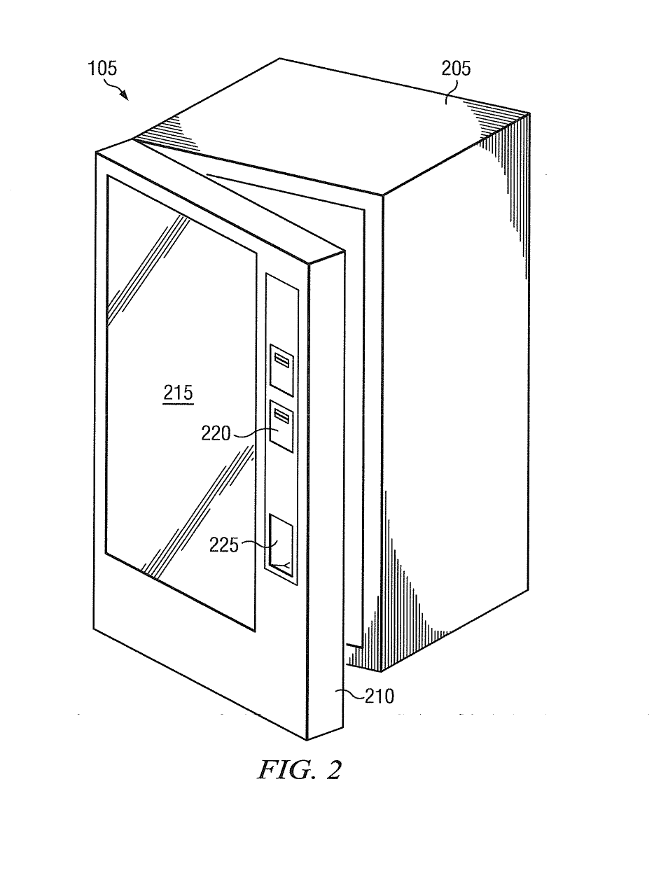

FIG. 2 illustrates a vending machine that implements a customer usage statistics collection system to collect rich customer insight data according to embodiments of the present disclosure. Although certain details will be provided with reference to the components of the vending machine 105 of FIG. 2, it should be understood that other embodiments may include more, less, or different components. It should be understood that although vending machine 105 is illustrated here by example, vending machine 105 represents any one of vending machines 105a through 105d.

Vending machine 105 is configured to store a plurality of products for sale via a vending operation. The vending machine 105 includes a cabinet 205 and a service door 210. The cabinet 205 and service door 210 form an enclosure, in which the plurality of products is stored. For some vending machines, the service door 210 is pivotally mounted to along a front edge of the cabinet 205, and spans the entire front face of the vending machine 105. For other vending machines, the service door 210 extends only across a portion of the front of the vending machine 105, and is formed in two portions of equal or unequal sizes. The two portions of such service doors can be mounted to swing open in opposite directions.

The vending machine 105 includes a user interface 215. The user interface 215 is located on a front face of the vending machine 105, such as on a front portion of the cabinet 205 or on the service door 210. The user interface 215 includes a display configured to render, such as by displaying on a screen, information in video format, graphical format, textual format, or a combination thereof. Preferably, the display is a touch screen display, such as a liquid crystal display (“LCD”) display with user touch detection.

The vending machine 105 includes a payment system 220. The payment system 220 is located on a front face of the vending machine 105, such as on a front portion of the cabinet 205 or on the service door 210. In certain embodiments, the payment system 220 is included within or as part of the user interface 215. The payment system 220 includes one or more of: a bill validator, a coin acceptor, a credit or debit card reader, and a cashless payment device reader, such as a reader of fobs, tags, tokens, quick-response codes (QR codes), and a screen of user devices 135). The payment system 220 receives currency, coins or other forms of payment from the customer and returns change as necessary. In certain embodiments, payment system 220 includes a light for each payment device contain therein that indicates the status of that payment device to a user.

The vending machine 105 includes an access port 225 located on the front face of the enclosure, such as within the service door 210. The access port 225 enables access to a delivery receptacle mounted within the service door 210 or in the cabinet 205. The access port 225 can have a delivery door or other mechanical system (e.g., rotatable delivery receptacle open on one side) for controlling and restricting customer access into the delivery receptacle, the interior of the vending machine, or both. In certain embodiments, particularly when the vending machine 105 is configured as a helical coil snack vending machines, the access port 225 is located near the bottom of the vending machine and extends across most of a width of the vending machine 105. In certain embodiments, the access port 225 is disposed below a large glass window allowing a view of the products within the cabinet 205 or below a large LCD screen that selectively presents images of advertisements or products available for vending. In certain embodiments, the vending machine 105 includes X-Y product retrieval and delivery mechanisms and a glass or substantially transparent front or large LCD front, but may include the access port 225 disposed to the side, at a height convenient to the customer for product retrieval without bending over.

Those skilled in the art will recognize that the complete structure of a vending machine 105 is not illustrated in the drawings, and the complete details of the structure and operation of the vending machine 105 is not described in the present disclosure. Instead, for simplicity and clarity, only so much of the structure and operation of the vending machine 105 as is unique to the present disclosure or necessary for an understanding of the present disclosure is illustrated and described.

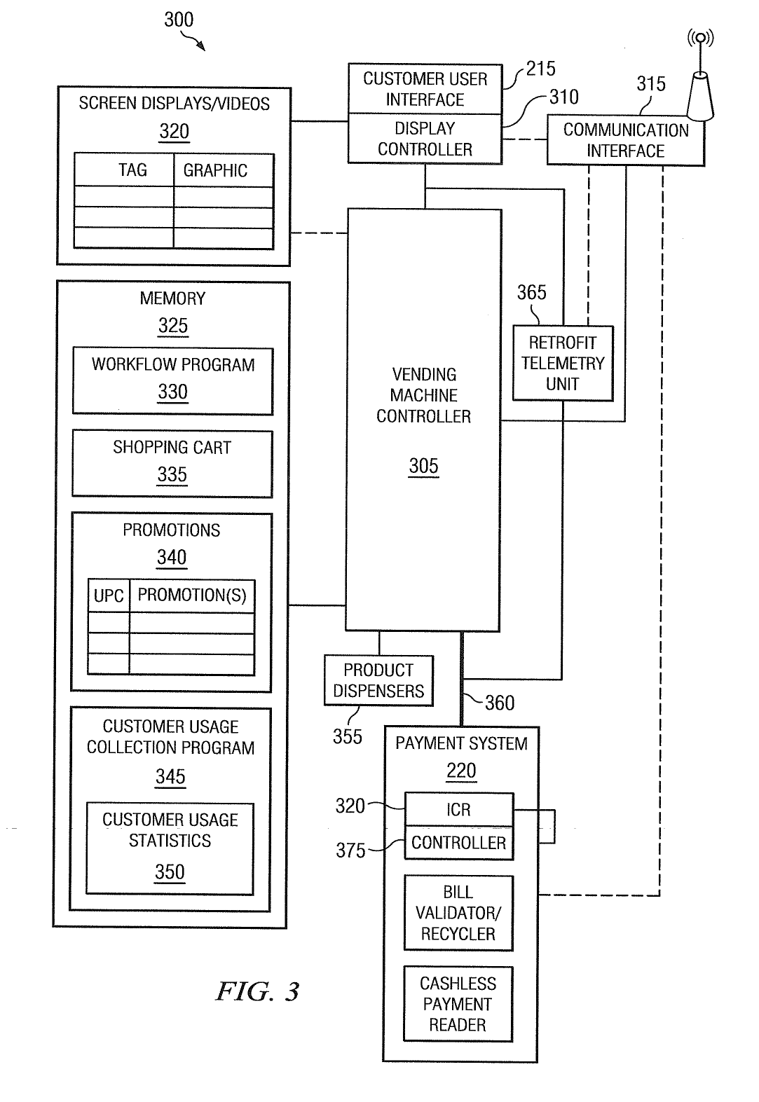

FIG. 3 illustrates a block diagram of selected electrical and electronic components of the vending machine in FIG. 2. Although certain details will be provided with reference to the components of the control system 300 of FIG. 3A, it should be understood that other embodiments may include more, less, or different components. The vending machine 105 includes the control system 300. The control system 300 is configured to enable the vending machine 105 to implement a customer usage statistics collection system to collect rich customer insight information.

The control system 300 includes a programmable vending machine controller (“VMC”) 305. The VMC 305 is configured to control one or more functions of the vending machine 105. For example, the VMC 305 controls vending operation of the vending machine 105. The VMC 305 includes processing circuitry to implement the customer usage statistics collection system to collect rich customer insight information.

The VMC 305 is coupled to and communicates with a display controller 310. The display controller 310 is further coupled to the user interface 215. For example, the display controller 310 provides content for display on the user interface 215. The display controller 310 also detects customer contact with the user interface 215 touch screen. For example, the display controller 310 detects a physical contact of a human, such as the customer, with the touch screen. The display controller 310 is configured to detect the location of the physical contact with the touch screen. According to the present disclosure, certain content for display includes one or more user controls (e.g., buttons or keys) that upon physical contact provide specific input to the control system 300. Display controller 310 is designed and configured to ensure that every key press and customer interaction (e.g., actuation of a user control) is deliberate. The display controller 310 is configured to provide display content prior to a detection of customer contact, such as in an idle mode, a stand-by mode, or an advertising mode of the vending machine 105. The display controller 310 also provides display content in response to one or more vending machine events, such as a customer contact, a tender of payment, a dispensing operation, a refund operation, a promotional offer, and the like.

The display controller 310 is coupled to and communicates with a display memory 320. The display memory 320 stores content for display on the user interface 215, such as screen displays and videos. The display memory 320 may include any suitable volatile or non-volatile storage and retrieval device(s). For example, the display memory 320 can include any electronic, magnetic, electromagnetic, optical, electro-optical, electro-mechanical, and/or other physical device(s) that can contain, store, communicate, propagate, or transmit information. The display memory 320 can store data and instructions for use by the display controller 310. For example, the instructions stored in the display memory 320 are configured to cause the display controller 310 to display graphical or textual information on the user interface 215. During a vend transaction and between transactions, the display controller 310 accesses the content for display stored in display memory 320. The display controller 310 renders screen displays and videos on the user interface 215 based on the accessed content.

The VMC 305 is optionally coupled to and communicates with the display memory 320. In certain embodiments, the content for display, screen display graphics and videos, is stored in memory 320 in exclusive association with a “tag”, or unique identifier, employed to access the respective content for display on the user interface 215.

The vending machine 105 includes a communication interface 315. The communication interface 315 enables communications with one or more of: the communications system 110, network operations center 115, vending machines 105a through 105d, and user device 135. For example, using the communications interface 315, the control system 300 can transfer data to external devices, such as a user device 135, a network operations center 115 or another vending machine 105. In certain embodiments, the vending machine 105 includes a plurality of communication interfaces 315 configured to enable communications with respective external systems or devices. The display controller 310 is also optionally coupled to the communication interface 315. While display controller 310 is communicably coupled to the data communications system 110, the user interface 215 provides a number of click-through web-pages for the customer to scroll or page through during an advertisement or vending operation. The VMC 305 creates a record of each uniform resource locator (“URL”), or website, displayed to the customer, accessed by the customer, or selected by the customer. The VMC 305 is coupled to and communicates with communication interface 315. Therefore, the VMC 305 is communicably coupled to communications system 110 through the communications interface 315. Communications can be through a wireless data transfer, a local area network Internet communication, or through a port provided in the vending machine 101, such as Universal Serial Bus (“USB”).

The VMC 305 is coupled to or includes another memory 325. While shown as separate from VMC 305, memory 325 may be implemented within the same integrated circuit as VMC 305. In addition, memory 325 and display memory 320 may be included within a single memory unit, such as partitioned sectors within a single memory unit. The memory 325 may include any suitable volatile and/or non-volatile storage and retrieval device(s). For example, the memory 325 can include any electronic, magnetic, electromagnetic, optical, electro-optical, electro-mechanical, and/or other physical device(s) that can contain, store, communicate, propagate, or transmit information. The memory 325 can store data and instructions for use by the VMC 305. Additionally, the memory 325 can store information related to the object to which the VMC 305 is attached, such as product information, promotion information, product inventory, co-located vending machine status, event history, maintenance history, and so forth. Memory 325 stores a workflow program 330 used to control the vending machine's operations during a vend transaction, a “shopping cart” data structure 335 used to hold identifiers for product selections (e.g., the product's Universal Product Code (“UPC”)) during the vend transaction, and optionally, a table 340 of promotions. In certain embodiments, the promotions in table 340 are associated with and organized by the UPC code for product selections.

The shopping cart data structure 335, promotions table 340, and screen displays/videos in display memory 320 are employed in the present disclosure in the same manner as counterpart features described in U.S. Provisional Patent Application Ser. No. 61/477,078, filed Apr. 19, 2011 and U.S. patent application Ser. No. 13/451,398 filed Apr. 19, 2012, each entitled “SHOPPING CART” PARADIGM FOR SINGLE-OR MULTI-VEND VENDING MACHINE TRANSACTION PROCESS FLOW.” The content of the above-identified patent documents is incorporated herein by reference.

Memory 325 also stores a customer usage collection program 345. The customer usage program 345 contains a plurality of instructions configured to cause the VMC 305 to store collected customer usage statistics 350 in memory 325. In certain embodiments, the customer usage collection program 345 is integrated into the workflow program 330. In certain embodiments, the customer usage collection program 345 receives customer usage statistics 350 from the data processors 120 or data warehouse 125 within network operations center 115. In another embodiment, the customer usage collection program 345 causes the VMC 305 to retrieve customer usage statistics 350 from the data processors 120 or data warehouse 125 within network operations center 115. In certain embodiments, the customer usage collection program causes the VMC 305 to calculate the customer usage statistics 350 prior to storage in memory 325.

The VMC 305 is coupled to and communicates with one or more product dispensers 355 (e.g., helical coils or an X-Y product retrieval mechanism) and payment system 220. The payment system 220 is optionally coupled to the communication interface 315, enabling communication with the communications system 110. The payment system 220 includes one or any combination of: a coin mechanism, a bill validator/recycler, a magnetic stripe card reader, a cashless payment device reader, such as a reader of fobs, tags, tokens, quick-response codes (QR codes), and screens of user devices 107. The VMC 305 receives signals from and controls the operation of product dispensers 355 and payment system 220.

In certain embodiments, the VMC 305 is coupled to the payment system 220 through a multi-drop bus (“MDB”) 360 that is communicably coupled to a retrofit telemetry unit 365. The retrofit telemetry unit 365 accesses the signals and messages transmitted between the VMC 305 and payment system 220. Retrofit telemetry unit 365 is also communicably coupled to the connection between the VMC 305 and display controller 310. The retrofit telemetry unit 365 accesses the signals and messages transmitted between the VMC 305 and display controller 310. The retrofit telemetry unit 365 is optionally coupled to communication interface 315, enabling communication with the communications system 110.

The ICR 370 includes a magnetic stripe reader/card swipe reader and/or a wireless, contactless cashless payment device reader. The ICR 370 and controller 375 communicate with VMC 305 and other subsystems within or external to vending machine 105 via a National Automatic Merchandising Association (NAMA) multi-drop bus (MDB), a Data Exchange (DEX) protocol communications channel, or both. The ICR 370 and controller 375 communicate with VMC 305 and other subsystems within or external to vending machine 105 to generate and utilize secure, anonymous unique customer identifiers during a cashless transaction.

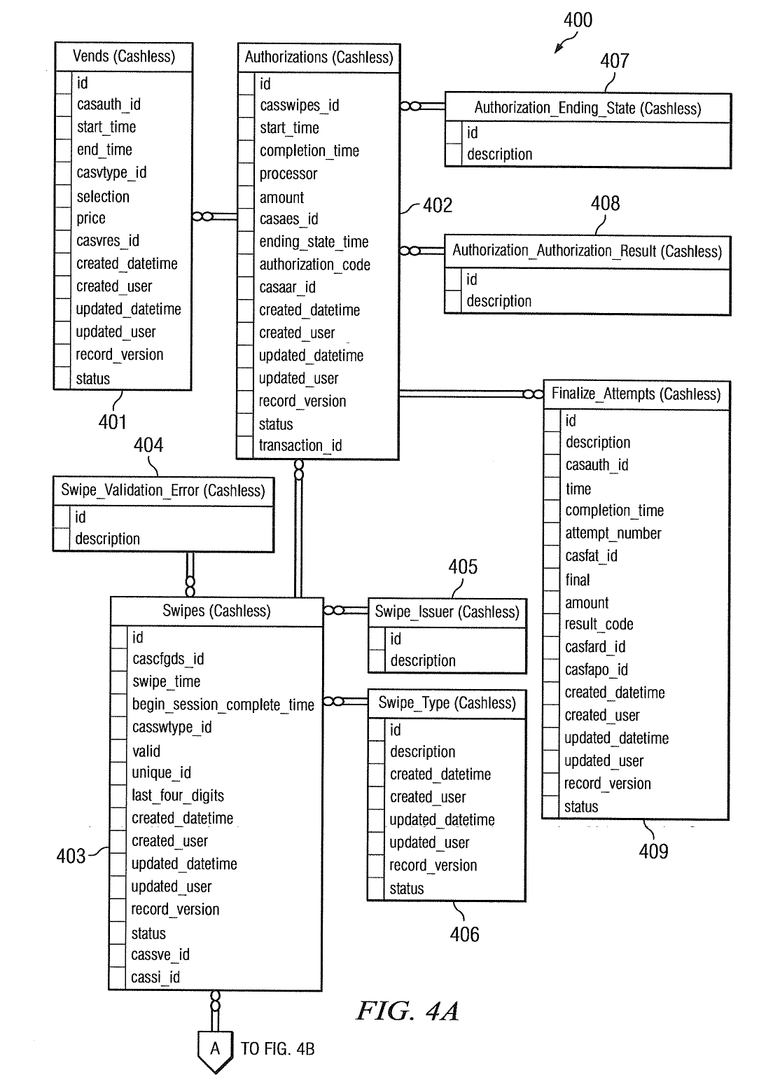

FIG. 4 illustrates a partial database entity relationship diagram for implements a customer usage statistics collection system according to embodiments of the present disclosure. The control system 300 collects rich customer insight for all vend transactions within the vending machine, including, but not limited to: the time at which the customer makes a selection, the results of the vend, the time of the vend, the time elapsed during the authorization process and the results of the authorization attempt(s), and whether a customer chose a multi-vend (a purchase of a plurality of products in a single transaction) or single vend (a purchase of one product in a single transaction). The control system 300 stores the collected data in database 400. The database 400 is configured as a plurality of relational databases. Each database within the plurality of relational databases stores respective rich customer insight information. For example, a first relational database 401 includes information regarding cashless vending transactions including: identification (“ID”), cash authorization ID, start time, end time, cash type, selection, created date time, created user, updated date time, updated user, record version, and status. Additional databases can include cashless authorizations 402, cashless swipes 403, cashless swipe validation errors 404, cashless swipe issuer 405, cashless swipe types 406, cashless authorization end states 407, cashless authorization attempts authorization results 408, cashless finalization attempts 409, cashless configuration data sets 410, cashless swipe types 412, and so forth. Appendix A attached hereto contains a sample eXtensible Markup Language (XML) schema and output file for producing database 380.

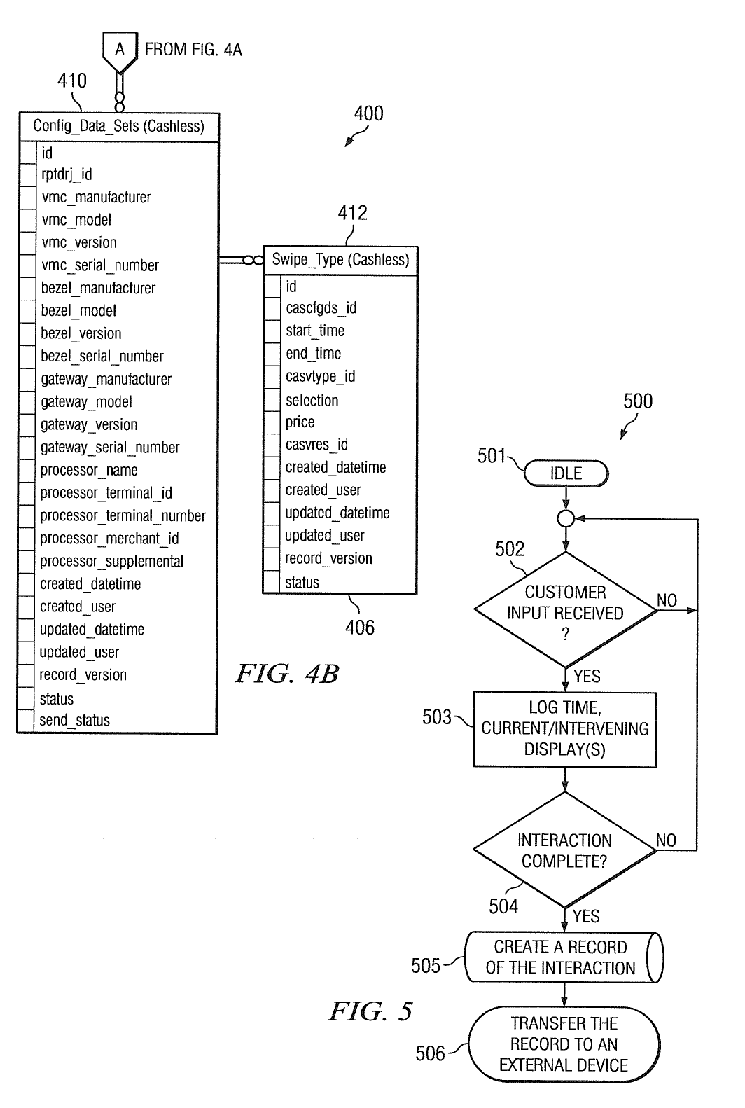

FIG. 5 illustrate processes for collecting customer usage statistics according to embodiments of the present disclosure. The vending machine 105 and various components in the network 100 interoperate to implement a customer usage statistics collection system for collecting rich customer insight data. The vending machine 105 executes the workflow program 330 to perform processes 400 and 500. The workflow program 306, together with the customer usage collection program 345, creates a record of each vend transaction and creates a record for every vend activity that accompanies each vend transaction performed by the vending machine 101.

FIG. 4 illustrates a process of collecting rich customer insight data from a vending transaction according to embodiments of the present disclosure. In block 405, a vend activity that starts a vend transaction is identified. During an idle mode, the user interface 215 may display videos, graphics, text, advertisements or other images designed to attract the attention of a potential consumer. In response to the consumer selecting an option on the user interface 215, the display controller 310 detects the selection by the customer. For example, to begin a vend transaction, the customer may touch a portion of the user interface 215, insert cash, swipe a magnetic stripe, or place a contactless cashless payment device within reading distance of the payment system 220. In response, the vending machine 105 detects the touch to the user interface 215, receives cash into the payment system 220, begins reading the magnetic stripe, of begins reading the contactless cashless payment device using the payment system 220, respectively. In certain embodiments, when no user input is received by user interface 215 or by payment system 220 after a specified time period, the control system 300 determines that a user response is a null set. That is, the user response is a null set when no input is received by user interface 215 or payment system 220 during a specified period of time. The workflow program 330 causes the VMC 310 to detect a start of a display of media content. In response to detecting the start of the display of media content, the VMC 305 identifies the initiation of the corresponding vend transaction. During a vend transaction and between transactions, the workflow program 330 will cause the VMC 305 to detect the start of a display of media content and identify the initiation of the vend activity that starts the vend transaction. The display controller 310 will perform a vend activity by causing the user interface 215 to show media content stored in memory 304. The media content can include any one or more of: videos, graphics, text, advertisements, web-pages, hyperlinks to web-pages, discounts, promotional offers, and the like.

The VMC 305 time-stamps the start of the vend activity in block 410. For example, at the start of the display of each media content stored in memory 304, VMC 305 time-stamps that start. The control system 300 includes a clock or other time calculation processing circuitry. The clock or other time calculation processing circuitry can be included in one of the components in the control system 300 or be an additional component of the control system 300. The work-flow program 330 causes the VMC 305 to create a retrieve a time from the clock or other time calculation processing circuitry. In certain embodiments, the VMC 305 retrieves the time from an external source such as via the communication interface 315. The VMC 305 identifies the time at which the vend activity was started, or the time at which the vend activity was detected as starting, and associates the identified time as a time-stamp for the start of the vend activity.

In block 415, the VMC 305 identifies the vend activity. The media content stored in display memory 320 includes a tag exclusively associated with the media content. That is, each video, image, text, web-page, and so forth, includes a tag that is exclusively associated with that video, image, text or web-page. In certain embodiments, the each element of a screen display includes a tag exclusively associated with that element. For example, a screen display may be comprises of a graphic, a video and hyperlink wherein a first tag is exclusively associated with the graphic, a second tag is associated with the video and a third tag is associated with the hyperlink. The VMC 305 identifies a “tag” exclusively associated to the specific screen display or video being displayed. The VMC 305 communicates with the display controller 310 to identify the media content displayed on the user interface 215. Alternatively, the VMC 305 polls the display memory 315 to identify the recent media content provided to the display controller 310.

In block 420, the VMC 305 time-stamps the end of the media content. The work-flow program 330 causes the VMC 305 to create a retrieve a time from the clock or other time calculation processing circuitry. In certain embodiments, the VMC 305 retrieves the time from an external source such as via the communication interface 315. The VMC 305 identifies the time at which the vend activity was completed, or the time at which the vend activity was detected as being terminated, and associates the identified time as a time-stamp for the end of the vend activity.

In block 425, the VMC 305 calculates the amount of time spent performing the vend activity. The workflow program 330 causes the VMC 305 to calculate the amount of time that elapsed between the start time-stamp and end time-stamp.

The VMC 305 creates a record of the vending activity in block 430. The VMC 305 stores the record in memory 325. The record includes information regarding the vend activity (i.e., display media content exclusively associated to a specified “tag”), the start time-stamp, the end time-stamp, and the elapsed time. The record chronicles an offer-for-selection vend activity and time-stamps that indicate a time of day that the vend transaction occurred as well as a time that a customer takes to make a product selection. In addition to creating a record of the vend activity that begins a vend transaction, the VMC 305 creates a record of each media content that is displayed during the transaction, including the media content that was displayed when the customer initiated the vend transaction.

In certain embodiments, the VMC 305 transfers the created records to an external device in block 435. The VMC 305 transfers one or more records to the external device 135 via a wired or wireless communication. Alternatively, the VMC 305 transfers one or more of the records via the communications system 110. The data processors 120 receive records from the vending machine 105. The data processors 120 store the records in a data warehouse 125. Thereafter, the records can be processed into rich structured query language (“SQL”) databases, and further stored in SQL databases in a data warehouse 125. Further, the data processors 120 can analyze the records to calculate customer usage statistics, such as historical statistics and histograms of the frequency at which certain vend activities occur during a specified period of time. The VMC 305 also receives customer usage statistics from the network operations center 115. The customer usage statistics are stored in and accessed from the customer usage statistics 350.

It should be noted that the collection of rich customer insight data may be aggregated across a number of vending machines, to allow better analysis of customer response trends (based on a larger sample). The aggregate data in such instances would be communicated by each vending machine 105a-105d to the network operations center 115, for accumulation and analysis. Alternatively, an individual vending machine 105 may be programmed to perform some level of analysis on the collected data, for local customization of customer interactions.

FIG. 5 is a high level flow chart for a process of customer usage statistics collection according to embodiments of the present disclosure. The work flow program 330 causes the VMC 305 to uniquely identify elements of the vend transaction. The process 400 begins with the vending machine “idle”—that is, not currently operating to perform a vend transaction with a customer, although the vending machine may be operating to present promotional displays to prospective customers and may also be monitoring and controlling internal conditions such as temperature.

The process 400 monitors for customer interaction with the vending machine (step 502). The customer interaction to be detected may be touching the customer interface, swiping a cashless payment token such as a credit card or wireless near field communication device, or (if the vending machine is equipped with a proximity detector such as a motion sensitive camera set to detect motion within a certain range) simply walking up to the vending machine. As long as no customer interaction is detected, the process continues polling for customer interaction. Upon detecting customer interaction with the vending machine, however, the process logs the current time, and an indication of the current display (step 503). The indication of the current display may be a display identifier for a graphical display or, for a video such as Flash content, a video identifier and a run time indicating the point within the video when the customer interaction occurred.

Thereafter, as long as customer interaction is ongoing (step 504), the process continues to monitor for customer input and to log the time of each customer input, any intervening displays between instances of customer input, and the current display at the time of each instance of customer input. For example, for a vend transaction, the process may log how many displays a user traversed before making a selection (and which displays), as well as the length of time that the customer took to make the selection. For certain events, such as display of a promotion within a series of promotions each displayed for a predetermined period of time, the event logged may include the failure of the customer to respond to display of a particular promotion.

Upon determining that customer interaction with the vending machine is complete (step 504), the process creates a record of the interaction (step 505) and transfers the record to an external system (step 506). The system may determine that customer interaction is complete by completion or cancellation of a vend transaction, or by an absence of customer input for at least a predetermined period of time.

Accordingly, when conducting a vending transaction, the customer may choose to view all products offered for sale. In response, the vending machine 105 creates a record of how long the customer viewed the display of the offered products. The vending machine also records when customer chooses to view specific information related to a particular product (e.g., nutrition facts label).

In certain embodiments, the vending machine 105 displays media content of one or a plurality of promotions 340 before the customer makes a first product selection, and the vending machine creates a record of each display. The vending machine can display a certain one or plurality of promotions in response to a product selection corresponding to a particular UPC code. For example, if a customer selects to buy a bag of chips, a product promotion may offer a discount on a can of soda. Similarly, if a customer selects to buy a bottle of juice by Brand A, a promotion may offer a discount on a cup of fruit from Brand B. The vending machine creates a record of which specific promotions were displayed, and which promotion the customer accepted, if any.

A promotion may require the customer to view a particular media content (e.g., a commercial or URL) in order to receive a discount on a particular product selection. If the customer accepts that promotional offer, the vending machine displays and creates a corresponding record of the particular media content shown, and applies the discount to the particular product selection.

The customer may choose to purchase one or a plurality of products in a single vend transaction. After a product is selected or added to the shopping cart 335, the workflow program 330 will time-stamp the end of an offer-for-selection vend activity 420. The workflow program 330 time-stamps the start of the new offer-for-selection vend activity and identifies that the subsequent offer-for-selection vend activity initiated. A last offer-for-selection vend activity concludes when the customer choses to dispense the one or plurality of product selections. In response to a completion of a debit of a cashless transaction or receiving a deposit of sufficient cash, the VMC 305 time-stamps the end of the payment authorization, returns any necessary cash change, causes the product dispensers 355 to consecutively deliver the one or plurality of product selections to the access port 225, and returns to an idle mode.

In certain embodiments, the vending machine 105 uses communication interface 315 to transmit one and a group of records of vend activities to the network operations center 115. A processor, such as the VMC 305 or data processors 120, can analyze records of vend transactions to calculate and determine customer usage statistics such as: the number of vend transactions per customer at one or a plurality of vending machines implementing a customer usage statistics collection system; the number of customers' choices to multi-vend using shopping cart; the type of payment (e.g., cash, Brand A credit card, Brand B debit card, etc.) used for a specific product; and a period of low consumer activity (i.e., time during which the frequency of vend transactions is low). Knowing the period(s) of low and high consumer activity, the VMC 305 can be programmed to offer certain promotions 340 (i.e., discounts) during certain times. For example, offering twenty-five cents off of Brand A chips during hours when Brand A chip sales are historically infrequent. The processor 305, 120 can determine the amount of time that a customer was present in front of a vending machine based on the length of a vend transaction. Using the specific products purchased and the payment type used in the payment type used in a particular transaction or group of transaction, the processor 305, 120 can correlate the price of a specific product with the type of payment used for purchasing that specific product.

The processor, such as the VMC 305 or data processors 120, can analyze records of vend activities to calculate and determine customer usage statistics such as: the amount of time a customer was present in front of particular media content (e.g., a screen display, video, promotion, website); the media content that was displayed at the time that at least one of the following occurred: the customer initiated a vend transaction and the customer made a particular product selection; the amount of time a vending machine takes to consecutively deliver a plurality of product selections per vend transaction; amount of time necessary to process a cashless payment authorization. The processor 305, 120 can determine amount of time that a customer was present in front of a vending machine based on the lengths of a plurality of records vend activities associated with one vend transaction. The processor 305, 120 can calculate the amount of time a customer spends in front of media content (e.g., promotional advertising) by analyzing the amount of time that elapsed between the start of the vend transaction and the end of a product selection.

In certain embodiments, the network operations center 115 monetizes the media content stored in display memory 320 and the promotions 340 stored in memory 332 by determining whether a customer responded to a display of particular media content. The data processors 120 analyze the records of media content that was displayed when a customer selected a product to purchase or accepted a multi-vend promotion offer. Using this analysis, the data processors 120 evaluate the effectiveness of media content.

Although various features have been shown in the figures and described above, various changes may be made to the figures. For example, the size, shape, arrangement, and layout of components shown in FIGS. 1 through 3B are for illustration only. Each component could have any suitable size, shape, and dimensions, and multiple components could have any suitable arrangement and layout. Also, various components in FIGS. 1 through 3B could be combined, further subdivided, or omitted, and additional components could be added according to particular needs. For instance, a system using multiple vending machines could be supported by only one control system. Further, each component in a device or system could be implemented using any suitable structure(s) for performing the described function(s). In addition, while FIG. 5 illustrates a series of steps or states, various steps in FIG. 5 could overlap, occur in parallel, occur multiple times, or occur in a different order.

Although the present disclosure has been described with an exemplary embodiment, various changes and modifications may be suggested to one skilled in the art. It is intended that the present disclosure encompass such changes and modifications as fall within the scope of the appended claims.

A sample XML file output is:

| | |
|---|---|
| | <?xml version=“1.0” encoding=“UTF-8” ?> |
| − | <ConsumerInsightReports> |
| − | <ConsumerInsightReport> |
| − | <AtlasTReportHeader> |
| | <ReportTime>2011-04-06723:17:47</ReportTime> |
| | <Timezone>8</Timezone> |
| | <ISN>200000192</ISN> |
| | <OID>Required</OID> |
| | <AID>AUS008</AID> |
| | <FirmwareVersion>8.5.11</FirmwareVersion> |
| − | <HardwareModel revision=“1.0.0”> |
| | <Model>AT1-206.27</Model> |

</HardwareModel>
</AtlasTReportHeader>

| | |
|---|---|
| − | <ConfigDataSets> |
| − | <ConfigDataSet> |
| − | <Config> |
| − | <VMC> |
| | <Manufacturer>DIX</Manufacturer> |
| | <Model>DN3000 5x6</Model> |
| | <Version>9915</Version> |
| | <SerialNumber>UV0606074216</SerialNumber> |

</VMC>

| | |
|---|---|
| − | <Bezel> |
| | <Manufacturer>CMS</Manufacturer> |
| | <Model>CPS-CR01</Model> |
| | <Version>100</Version> |
| | <SerialNumber>N/A</SerialNumber> |

</Bezel>

| | |
|---|---|
| − | <Gateway> |
| | <Manufacturer>CMS</Manufacturer> |
| | <Model>Navigator</Model> |
| | <Version>8.5.11</Version> |
| | <SerialNumber>200000192</SerialNumber> |

</Gateway>

| | |
|---|---|
| − | <Processor> |
| | <ProcessorName>Heartland</ProcessorName> |
| | <MerchantID>2147483647</MerchantID> |
| | <TerminalID>1</TerminalID> |
| | <TerminalNumber>1</TerminalNumber> |
| | <Supplemental /> |

</Processor>
</Config>

| | |
|---|---|
| − | <Swipes> |
| − | <Swipe> |
| | <SwipeTime>2011-04-06T23:17:21</SwipeTime> |
| | <SwipeType>MagStripe</SwipeType> |
| | <Valid>true</Valid> |
| | <ValidationError/> |
| | <Issuer>MASTER CARD</Issuer> |
| | <LastFourDigits>0014</LastFourDigits> |
| | <UniqueID>12345</UniqueID> |
| − | <Authorizations> |
| − | <Authorization> |
| | <StartTime>2011-04-06T23:17:28</StartTime> |
| | <Processor>Heartland</Processor> |
| | <Amount>150</Amount> |
| | <EndingState>Credit Finalize Response</EndingState> |
| | <EndingStateTime>2011-04-06T23:17:42</EndingStateTime> |
| | <AuthorizationCode>018892</AuthorizationCode> |
| | <AuthorizationResult>Authorization Success</AuthorizationResult> |
| − | <Vends> |
| | <Vend> |
| | <StartTime>2011-04-06T23:17:28</StartTime> |
| | <EndTime>2011-04-06T23:17:42</EndTime> |
| | <Type>Credit</Type> |
| | <Selection>C</Selection> |
| | <Price>150</Price> |
| | <Result>Vended</Result> |

</Vend>
</Vends>

| | |
|---|---|
| − | <FinalizeAttempts> |
| − | <FinalizeAttempt> |
| | <Time>2011-04-06T23:17:42</Time> |
| | <AttemptNumber>1</AttemptNumber> |
| | <Type>Capture</Type> |
| | <Final>true</Final> |
| | <ResultDescription>Transaction Success</ResultDescription> |
| | <Amount>150</Amount> |
| | <ResultCode /> |
| | <ProcessorOperation>Processor Capture</ProcessorOperation> |

</FinalizeAttempt>
</FinalizeAttempts>
</Authorization>
</Authorizations>
</Swipe>
</Swipes>
</ConfigDataSet>
</ConfigDataSets>
</ConsumerInsightReport>
</ConsumerInsightReports>

What is claimed is:

1. A vending machine, comprising:
an enclosure configured to store a plurality of products available to be vended;
a customer interface configured to display content to customers and to receive input from customers; and
a control system configured to collect rich customer insight information, the rich customer insight information comprising at least a timestamp for a time of each customer input into the customer interface and a content identifier corresponding to content being displayed at the time of each customer input into the customer interface.

2. The vending machine according to claim 1, wherein the customer input comprises at least one of:
one or more menu selections by the customer;
a product selection by the customer;
a request to view a web-site;
a request to view specified media content;
a selection to commence a vend transaction; and
no input received by the user interface in a specified time period.

3. The vending machine according to claim 1, wherein the control system is configured to at least one of:
store the rich customer information; and
transmit the rich customer insight information to at least one of an external mobile device and a network operations center.

4. The vending machine according to claim 1, wherein the rich customer information comprises a duration of time in which portions of an identified media content are displayed between consecutive instances of customer input.

5. The vending machine according to claim 1, wherein the control system is configured to uniquely identify each vend transaction and to associate the vend transaction identifier with a record of customer interaction during the vend transaction.

6. The vending machine according to claim 1, wherein the rich customer information comprises identifiers for a sequence of content displayed to the customer before a customer selection is detected.

7. The vending machine according to claim 1, wherein, based on statistical information generated from the rich customer insight information, the control system is configured to at least one of:
cause the user interface to display selected ones of the media content at predetermined times or with predetermined frequency; and
cause the vending machine to discount one or more products during a predetermined time-of-day.

8. A network comprising a plurality of vending machines each according to claim 1, the network further comprising:
a network operation center configured to receive accumulations of rich customer insight information from each of the vending machines.

9. A method, comprising:
storing a plurality of products available to be vended within an enclosure;
displaying content to customers and receiving input from customers at a customer interface; and
collecting rich customer insight information, the rich customer insight information comprising at least a timestamp for a time of each customer input into the customer interface and a content identifier corresponding to content being displayed at the time of each customer input into the customer interface.

10. The method according to claim 9, wherein the customer input comprises at least one of:
one or more menu selections by the customer;
a product selection by the customer;
a request to view a web-site;
a request to view specified media content;
a selection to commence a vend transaction; and
no input received by the user interface in a specified time period.

11. The method according to claim 9, further comprising:
storing the rich customer information; and
transmitting the rich customer insight information to at least one of an external mobile device and a network operations center.

12. The method according to claim 9, wherein the rich customer information comprises a duration of time in which portions of an identified media content are displayed between consecutive instances of customer input.

13. The method according to claim 9, further comprising:
uniquely identifying each vend transaction; and
associating the vend transaction identifier with a record of customer interaction during the vend transaction.

14. The method according to claim 9, wherein the rich customer information comprises identifiers for a sequence of content displayed to the customer before a customer selection is detected.

15. The method according to claim 9, further comprising:
based on statistical information generated from the rich customer insight information, at least one of:
causing the user interface to display selected ones of the media content at predetermined times or with predetermined frequency, and
discounting one or more products during a predetermined time-of-day.

16. A method comprising:
displaying media content on a user interface;
detecting a response to the media content; and
in response to the detected response, collecting rich customer insight information, the rich customer insight information comprising a customer response to respective portions of the media content.

17. The method according to claim 16, wherein the customer responses comprise at least one of:
a product selection by the user;
a request to view a web-site;
a request to view specified media content;
a selection to commence a vend transaction; and
no input received by the user interface in a specified time period.

18. The method according to claim 18, further comprising at least one of:
storing the rich customer information;
transmitting the rich customer insight information to at least one of: an external device; and a network operations center.

19. The method according to claim 16, further comprising at least one of:
identifying a duration of time in which respective portions of the media content is displayed before detecting the response to the media content; and
applying one or more time-stamps to the rich customer insight information.

20. The method according to claim 16, further comprising:
uniquely identifying a vend transaction; and
associating the vend transaction to at least one of a corresponding vend activity and one or more of the display media content.
